(19) United States
(12) Patent Application Publication
(10) Pub. No.: US 2024/0295101 A1
(43) Pub. Date: Sep. 5, 2024

(54) Lather Shower Head

(71) Applicant: Zobon S.A. Jomah, Newark, NJ (US)

(72) Inventor: Zobon S.A. Jomah, Newark, NJ (US)

(73) Assignee: Tetia T. Jomah, Newark, NJ (US)

(21) Appl. No.: 18/177,741

(22) Filed: Mar. 2, 2023

(51) Int. Cl. E03C 1/046; E03C 1/04

(52) U.S. Cl. CPC E03C 1/046; E03C 1/0408

(57) ABSTRACT

An improved shower head utilizes a main body having two ends, a top, and bottom. The body of the improved shower head defines an interior space or compartment within the top of the main body. A soap sleeve is positioned within the interior space or compartment, and the turning of a water direction lever may direct water flow to the soap sleeve and turn the water soapy. The soapy water may egress through specific water veins positioned at a distal end of the main body. The water direction lever combined with two distinct water lines within the main body may allow a bather to advantageously switch between soapy and non-soapy water.

### BACKGROUND OF THE INVENTION

The present disclosure relates generally to an improved shower head. More particularly, the present disclosure relates to a shower head that advantageously allows a person taking a shower (i.e., a bather) to switch between soapy and non-soapy water.

Existing shower heads allow bathers to switch between various water modes by rotating the shower head. However, existing shower heads do not provide bathers with the functionality of having soapy or non-soapy water flow through the shower head and onto their body. Therefore, what is needed is an improved shower head having all of the further described features and advantages.

### SUMMARY OF THE INVENTION

The subject matter of this application may involve, in some cases, interrelated products, alternative solutions to a particular problem, and/or a plurality of different uses of a single system or article.

In one aspect, a shower head is disclosed. In this aspect, the shower head has a body, and the body has a proximal end, a distal end, a top, and bottom. The body also has a plurality of water veins positioned on the distal end of the body, and a soap pocket cap connected to the top of the body.

### BRIEF DESCRIPTION OF DRAWINGS

FIG. 1 provides a perspective view of one embodiment of the present disclosure.

FIG. 2 provides a semi cross-sectional perspective view of another embodiment of the present disclosure.

### DETAILED DESCRIPTION OF THE INVENTION

The detailed description set forth below in connection with the appended drawings is intended as a description of presently preferred embodiments of the invention and does not represent the only forms in which the present disclosure may be constructed and/or utilized. The description sets forth the functions and/or the sequence of steps for constructing and operating the invention in connection with the illustrated embodiments.

Generally, the present disclosure concerns an improved shower head. In most embodiments the shower head may comprise an interior compartment to hold a bar of soap. Specifically, the shower head may have two water lines within its body, wherein one water line may direct water through the compartment holding the bar of soap, and the other water line may avoid the compartment holding the bar of soap. This mechanism may allow a bather to advantageously switch between soapy and non-soapy water.

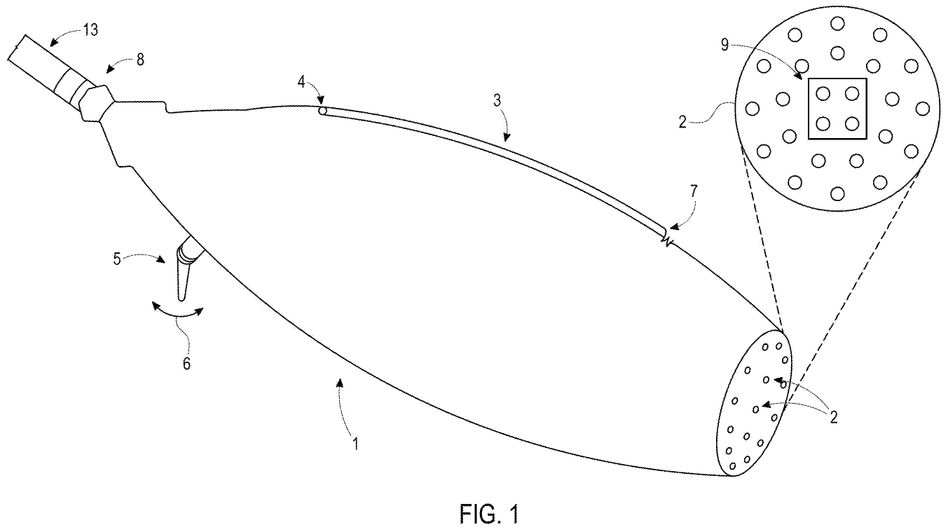

Turning now to FIG. 1, which provides a perspective view of one embodiment of the main body 1 of the shower head. The body 1 has a plurality of water veins 2 at a distal end for the egress of non-soapy water. The shower head also has a soap pocket cap 3 connected to the top of the body 1 by a hinge 4. The hinge 4 permits the opening and closing of the soap pocket cap 3. The soap pocket cap 3 can be pressed into a closed position, which causes the soap pocket cap 3 to form a water-tight seal 7 with the body 1 of the shower head. A water direction lever 5 is attached to the bottom of the body 1, which may be turned 6 clockwise or counterclockwise. In this embodiment, the body 1 of the shower head is connected to a water pipe 13 by a female adapter 8, which ensures that the body 1 remains in a fixed position during bathing. The turning of the water direction lever 5 may cause water flow from the water pipe 13 to be directed to specific water veins 9 (shown in the enlarged section of FIG. 1). The specific water veins 9 are only a portion of the plurality of water veins 2 and are meant to allow the egress of soapy water. In one embodiment, the water may turn soapy by the further described mechanism.

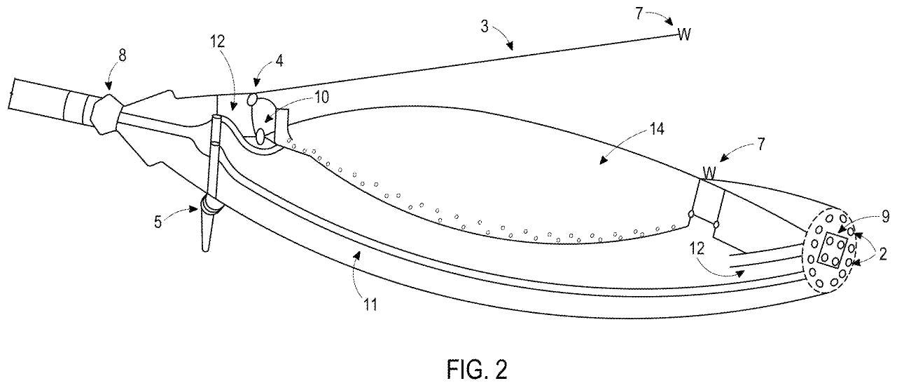

Turning now to FIG. 2, which provides a semi, cross-sectional perspective view of the body 1 of the shower head. In this embodiment, the soap pocket cap 3 is in an open position and no longer forms a water-tight seal 7 with the body 1. Inside the body 1, the shower head includes a soap sleeve 14, which may be loaded with a bar of soap and turned up to one hundred eighty degrees (180°) by a rotating hinge 10 attached to a proximal end of the soap sleeve 14. While bathing, the water direction lever 5 may be turned clockwise, and water from the water line 13 will be directed through the soapy water line 12 at a proximal end of the soap sleeve 14. The water pressure at the proximal end of the soap sleeve 14 causes the hinge 10 to rotate 180° and position the soap toward the bottom of the body 1 and into the stream of water. This makes the water soapy, and the soapy water then flows through the water line 12 positioned at a distal end of the soap sleeve 14, yet not connected to the soap sleeve 14. This soapy water then flows out through the soapy water veins 9 onto the bather. When the direction lever 5 is rotated counterclockwise, non-soapy water flows through the regular water line 11 and egresses through water veins 2 onto the bather. At the same time, the soap sleeve 14 returns to the top position and out of water, which critically prevents an accumulation of soap scum and other undesirable material from forming within the sleeve 14. This process is repeatable.

While several variations of the present disclosure have been illustrated by way of example in preferred or particular embodiments, it is apparent that further embodiments could be developed within the spirit and scope of the present disclosure, or the inventive concept thereof. However, it is to be expressly understood that such modifications and adaptations are within the spirit and scope of the present disclosure, and are inclusive, but not limited to the following appended claims as set forth.

What is claimed is:

1. A shower head comprising:
a body, the body comprising a proximal end, a distal end, a top, and a bottom;
a plurality of water veins positioned on the distal end of the body; and
a soap pocket cap connected to the top of the body.

2. The shower head of claim 1 wherein a hinge connects the soap pocket cap to the top of the body.

3. The shower head of claim 1 further comprising a water direction lever connected to the bottom of the body.

4. The shower head of claim 1 further comprising a female adapter connected to the proximal end of the body.

5. The shower head of claim 1 wherein the soap pocket cap forms a water tight seal with the top of the body.

6. The shower head of claim 1 wherein the body defines an interior space within the top of the body.

7. The shower head of claim 6 further comprising a soap sleeve positioned within the interior space.

8. The shower head of claim 7 wherein the soap sleeve is connected to the body by a rotating hinge.

9. The shower head of claim 1 further comprising two water lines.

10. The shower head of claim 9 wherein a rotation of a water direction lever directs a water flow through one of the two water lines.
